(19) United States
(12) Patent Application Publication
(10) Pub. No.: US 2021/0354051 A1
(43) Pub. Date: Nov. 18, 2021

(54) SYSTEM AND METHOD FOR CLOSED CYCLE PREPARATIVE SUPERCRITICAL FLUID CHROMATOGRAPHY

(71) Applicant: Vitalis Extraction Technology Inc., Kelowna (CA)

(72) Inventor: James Anthony Seabrook, West Kelowna (CA)

(21) Appl. No.: 17/320,358

(22) Filed: May 14, 2021

Related U.S. Application Data
(60) Provisional application No. 63/025,893, filed on May 15, 2020.

(51) Int. Cl. B01D 15/20; B01D 15/40; B01D 15/18; B01D 15/24; B01D 11/02

(52) U.S. Cl. CPC B01D 15/206; B01D 15/40; B01D 11/0203; B01D 15/1885; B01D 15/247; B01D 15/1871

(57) ABSTRACT

A preparative closed cycle supercritical fluid column chromatography system, device, and method of isolating high volumes of pure components from mixtures using a supercritical solvent. Bulk fractions of desirable material from plants can be obtained using supercritical fluid column chromatography with a chromatography column. A chemical sensor downstream the chromatography column detects chemical species eluted from the column and a plurality of collection columns collects the bulk fractions of product with a control system controlling the collection valves based on detection of chemical species at the chemical sensor.

### CROSS REFERENCE TO RELATED APPLICATION

This application claims priority to U.S. provisional Ser. No. 63/025,893 filed on May 15, 2020, the contents of which are hereby incorporated by reference in their entirety.

### FIELD OF THE INVENTION

The present invention pertains to a closed cycle preparative supercritical fluid column chromatography system and method. The present invention also pertains to an apparatus, system, and method for extracting bulk fractions of desirable material from plants using closed cycle supercritical fluid chromatography.

### BACKGROUND

Column chromatography is a method used to purify and isolate component parts from a chemical mixture by separating the component parts on a column using a solvent and collecting the fractions. The solvent is then removed from the collected fractions leaving a purified chemical or component. Supercritical fluid chromatography (SFC) is a chromatographic separation technique that utilizes a supercritical fluid such as carbon dioxide (CO₂) as a mobile phase solvent, optionally combined with other solvents or co-solvents, to provide variable solubility and achieve the desired separation. A supercritical fluid (SCF) is any substance at a temperature and pressure above its critical point, where distinct liquid and gas phases do not exist. Above the critical point, CO₂ behaves as a supercritical fluid above its critical temperature (304.25 K, 31.10° C., 87.98° F.) and critical pressure (72.9 atm, 7.39 MPa, 1,071 psi, 73.9 bar). In order to keep the mobile phase in proper fluid phase, the chromatographic flow path is pressurized, typically to a pressure of at least 1100 psi for CO₂, and temperature is controlled to maintain the desired supercritical fluid flow properties.

Another purification technique is supercritical or subcritical fluid extraction (SFE). In this technique, the goal is separating a desirable extract from a solid matrix where supercritical fluid is the extracting solvent. After extraction, the solvent can be easily separated from the extract by decreasing the pressure and evaporating the solvent. Supercritical carbon dioxide (SCO₂) is a fluid state of carbon dioxide where it is held at or above its critical temperature and critical pressure. CO₂ extraction is generally considered to be a safe and clean method for the extraction of desirable materials especially from temperature sensitive materials such as plants, which are used for the preparation of drugs, cosmetics, colorants, spices, and food additives, and which can contain a wide variety of chemical species. Extraction with supercritical fluid CO₂ has been used to remove active constituents from foods such as caffeine from coffee beans, and humulene and other flavors from hops (Humulus lupulus). Extraction of desirable oils and active constituents from plants removes plant cell constituents including but not limited to fats, waxes, carbohydrates, proteins, and sugars. Extraction of cannabis plant material is also used to formulate medicinal compositions containing sesquiterpenes, terpenes, cannabinoids (for example Tetrahydrocannabinol (THC), Cannabidiol (CBD), Cannabinol (CBN), etc.), flavonoids, pigments, sugars, chlorophylls, waxes, lignin, pectins, starches, and cellulose. Pharmaceutical-grade cannabis concentrates can be prepared by extracting out the desirable active terpene materials from the non-active matrix plant materials. SFE is a bulk separation technique which does not necessarily attempt to individually separate the components. Typically, a secondary step is required to determine individual components.

In analytical high-performance liquid chromatography (HPLC) where very small amounts of sample mixture is analyzed, it is common to be able to detect components in amounts in the microgram range. However analytical techniques are not easily adaptable for preparative separation, at least because the amount of each component in the sample is much greater, ranging of milligrams to multiple grams or kilograms of each component in each separation. Preparative chromatography systems also require collection of the separated components, which requires elutions with large volumes of liquid solvent, and collection of multiple fractions in large containers. In addition, after a successful preparative chromatography elution, removal of the mobile phase or solvent from the isolated components is necessary to obtain the pure desired product. Even in optimal conditions, only a small fraction of the mobile phase contains components of the interest. Accordingly, very large volumes of the mobile phase solvent containing the undesired components will be wasted.

In the pharmaceutical and botanical industries, the demand for purified compounds, like isolated cannabinoids, is increasing steadily. It has become highly desirable to obtain components of the highest available purity in the largest quantities. Recent advances in SFE technology has provided reliable, large scale, industrial extraction systems capable of extracting pure botanical oils from 10 to 1000 kg of solid matrix in each run. However the current chromatography techniques and other techniques for isolation of pure compounds are the bottle neck for increasing the production rate for pure pharmaceutical botanical isolates like isolated cannabinoids. In current preparative chromatography technology, as an example in available HPLC or liquid chromatography (LC) technology, to isolate 1 kg of cannabidiol (CBD) from the raw cannabis oil, approximately 100-400 kg of volatile organic solvent, usually ethanol, is required. Of the solvent used, most can be recovered but requires time and energy intensive distillation procedures and still results in large amounts of solvent waste as it contains undesirable components. In the use of volatile organic solvents for standard preparative chromatography, the time required is also lengthy, in addition to the energy and time-intensive distillation procedure to separate the organic solvent from the final pure product. As a result, preparative scale chromatography using volatile organic solvents results in a tremendous amount of solvent waste, time, as well as energy expenditure.

SFC for both analytical and preparative applications was described in U.S. Pat. Nos. 6,413,428 and 6,652,753 to Berger et al. which disclose a fractionated sample collection process and device for collecting the separated components in open vessels in supercritical chromatography. In Berger et al., the supercritical fluid is not recovered and is evaporated in the open collection chambers during product recovery.

In another example, U.S. Pat. No. 9,933,399 to Fairchild and Wyndham discloses heating techniques for improving the quality of the separation of the components inside a SFC column by keeping the fluid properties of the mobile phase constant inside the column.

In another example, U.S. Pat. Nos. 6,309,541 and 6,508,938 to Maiefski et al. describe using a SFC system with multiple chromatography columns for continuous separation output by shifting the flow between the columns.

There remains a need for efficient large industrial scale supercritical fluid preparative chromatographic separation with closed cycle solvent recycling. There also remains a need for adaptive configurations and devices for large scale closed cycle supercritical fluid preparative column chromatography, in particular for remediation of cannabis extract.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a closed cycle preparative supercritical fluid column chromatography system and method for extracting bulk fractions of pure compounds from raw material. Another object of the present invention is to provide a method and device for preparing the stationary phase of a supercritical chromatography column.

In an aspect there is provided a supercritical fluid column chromatography system comprising: a chromatography column comprising a stationary phase; a chemical sensor downstream the chromatography column for detecting chemical species eluted from the chromatography column; a heat exchanger downstream the chemical sensor; a plurality of collection columns downstream the chemical sensor, each collection column comprising, in series: a collection control valve receiving fluid to the collection column; and a separator to separate supercritical process fluid from product; a supercritical fluid collector fluidly connected with the separator on each collection column; a supercritical fluid condenser fluidly connected to the supercritical fluid collector; a fluid reservoir fluidly connected to the supercritical fluid condenser and the chromatography column; and a control system for controlling the collection valve on each of the plurality of collection columns based on detection of chemical species at the chemical sensor.

In an embodiment, the system further comprises a co-solvent tank upstream the chromatography column.

In another embodiment, the separator in the collection column is a cyclone separator.

In another embodiment, the system further comprises a diverter fluidly connected to the chemical sensor.

In another embodiment, the chemical sensor is an off-line sensor, an in-line sensor, or an on-line sensor.

In another embodiment, the system comprises a plurality of chromatography columns.

In another embodiment, the plurality of chromatography columns are arranged in sequence, in series, or a combination thereof.

In another embodiment, the sensor is selected from a mass spectrometer, photodiode array using ultraviolet wavelengths, ultraviolet (UV) sensor, visible light sensor, near infrared (NIR) sensor, Raman spectrometer, microwave sensor, or a combination thereof.

In another embodiment, the system further comprising one or more of a temperature sensor, pressure gauge, pressure release valve, and flow sensor.

In another embodiment, the system comprises more than two collection columns.

In another embodiment, the system further comprises a product homogenizer fluidly connected to an exit valve on at least some of the plurality of collection columns.

In another embodiment, the chromatography column comprises a column packing device for compacting the stationary phase.

In another embodiment, the system further comprises a sample homogenizer upstream the chromatography column.

In another embodiment, the sample homogenizer comprises an induced cavitation mixing apparatus.

In another aspect there is provided a method of separating components in a mixture in a supercritical fluid flow system, the method comprising: loading a sample mixture onto a chromatography column; pumping pressurized supercritical fluid onto the chromatography column; detecting effluent from the chromatography column with a chemical sensor; receiving data, at a control system, from the chemical sensor regarding the presence of a component fraction in the effluent; controlling, with the control system, a sample collection valve on a collection column to collect the component in the effluent; and re-circulating the supercritical fluid from the collection column back into the supercritical fluid flow system.

In an embodiment, the method further comprises adding a co-solvent to the supercritical fluid.

In another embodiment, the co-solvent is ethanol, methanol, isopropanol, hexane, or a combination thereof.

In another embodiment, component fractions are recombined downstream the collection column.

In another embodiment, the method comprises directing component fractions to different collection columns.

In another aspect there is provided a method of preparing the stationary phase of a supercritical chromatography column comprising: filling the chromatography column with stationary phase; applying a column packing device to the stationary phase, the column packing device comprising a column cap sealing the chromatography column and a piston movable along the column axis relative to the column cap; pumping supercritical fluid onto the stationary phase in the chromatography column; injecting fluid between the column cap and the piston to activate movement of the piston away from the column cap; compacting the stationary phase with the piston; and securing the piston in place to immobilize the stationary phase.

In an embodiment, the chromatography column is a preparative chromatography column.

In another embodiment, the chromatography column is in a supercritical fluid chromatography system.

In another embodiment, the chromatography column has a volume of between 1 litre to 10,000 litres.

In another embodiment, the stationary phase is compacted to a desired pressure or density.

In another embodiment, the fluid injected between the column cap and the piston comprises supercritical fluid.

In another aspect there is provided a column packing device for a supercritical fluid chromatography column comprising: a column cap secured to the chromatography column; a piston for applying pressure to stationary phase inside the chromatography column, the piston movable along the column axis relative to the column cap; a packing piston rod coupled to the piston; and a fluid port between the piston and the column cap, wherein injection of fluid through the fluid port between the column cap and the packing piston activates movement of the piston away from the column cap to pressurize the stationary phase.

In an embodiment, the device further comprises a regulator to regulate the pressure differential between the column packing device and the chromatography column.

In another embodiment, the device further comprises a locking mechanism to immobilize the piston relative to the column cap.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a diagram of an example closed cycle preparative supercritical fluid chromatography (SFC) system;

FIG. 2 is a closeup of a collection column in a closed cycle preparative SFC system;

FIG. 3 is a process diagram for closed cycle preparative SFC;

FIG. 4 is a cross-sectional view of a chromatography column for SFC with an integrated column packing device;

FIG. 5 is a cross-sectional isometric view of a chromatography column for SFC with an integrated column packing device;

FIG. 6A is an enlarged cross-sectional view of the column packing device in a chromatography column in an elevated position;

FIG. 6B is an enlarged cross-sectional view of the column packing device in a chromatography column in a compressed position;

FIG. 7 is a side view of a chromatography column packing device;

FIG. 8 is an isometric cross-sectional view of a column packing device;

FIG. 9 is a flowchart for a method of separation and fractionation in a supercritical fluid chromatography system;

FIG. 10 is an example graph of fluid flow for oil, mobile phase and co-solvent in a SFC system; and

FIG. 11 illustrates different solvent and elution gradient types that can be used in superfluid column chromatography.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The term “closed cycle,” also known as a closed system, as used herein is understood to mean that the supercritical fluid flow is maintained within the system and recirculated through the system without venting to the environment. In particular, this means that the chromatography system is enclosed and fluidly separated from the environment.

Herein is described a preparative supercritical fluid column chromatography system and apparatus, and a method for extracting large volumes of pure components from mixtures using a supercritical solvent in a closed cycle. The extraction of purified compounds from a complex mixture at industrial scale provides flexibility and efficiency in a high-volume production environment. In a small chromatography system, the use of CO₂ could be considered consumable where there is low economic benefit and low environmental impact to discharging all CO₂ used in the process. However in a large, industrial scale preparative CO₂ chromatography system with high cumulative flow on the order of thousands of liters per day, it is economically and environmentally advantageous to recycle the supercritical CO₂ solvent back to mobile phase of the chromatography system. Carbon dioxide recovery in the presently described recirculating supercritical solvent system and recoverable solvent systems decrease both carbon dioxide and co-solvent use thus producing less solvent waste than traditional chromatography systems. The present system collects and recirculates supercritical fluid back to the system in a closed cycle by raising the fluid temperature in a heat exchanger and removing it as gas, then recondensing the gas so that it can be used again. Use of supercritical carbon dioxide as a solvent yields products with less solvent contamination as solvent is easily evaporated from the desired product or product mixture. The present system is thus a substantially closed cycle such that solvents and elution fluids can be recycled, leading to a more environmentally sustainable industrial volume chromatographic purification process. The described SFC chromatography system and method can also be used as secondary step to separate the desired components from a plant oil mixture which is extracted from a superfluid extraction system.

Some benefits of using a supercritical fluid such as CO₂ in a preparative chromatographic extraction and purification processes are that a much smaller amount of solvent is required in comparison to a conventional liquid chromatography system, removal of the solvent from the purified product is less energy intensive, and substantially all of the solvent can be recaptured. In one example, using the presently described apparatus and method, 1 kg of CBD can be isolated using only 2-4 kg of ethanol as co-solvent with 95-100% of the main elution solvent (CO₂) recycled in a closed cycle process. This results in only 2-4 kg of ethanol requiring separation from the isolated CBD to achieve the final product. Using the present method and apparatus the chromatography procedure makes it possible to possible to isolate several kilograms of product in one working day while keeping the use and generation of organic waste to a minimum.

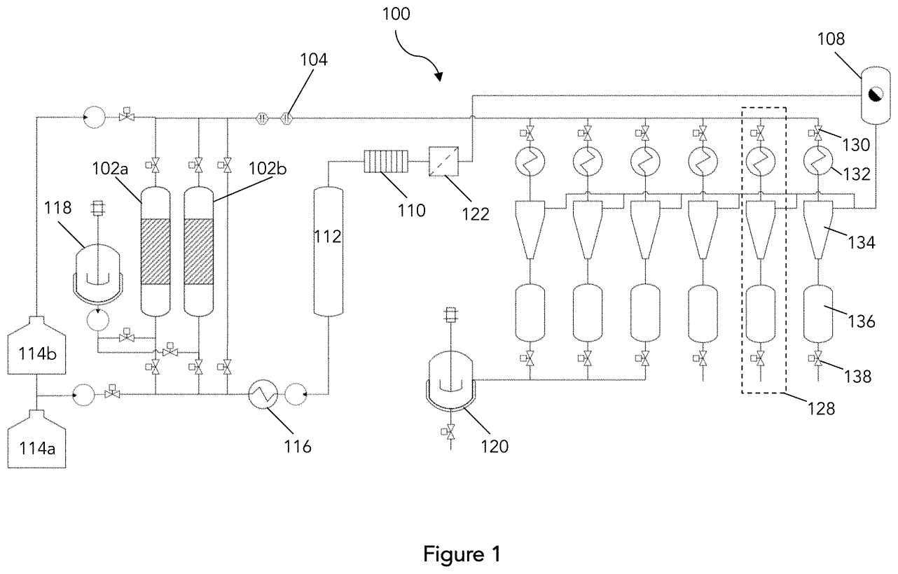

FIG. 1 is a diagram of an example closed cycle preparative supercritical fluid chromatography (SFC) system 100. The supercritical fluid column chromatography system 100 comprises a supercritical fluid flow path and at least one high volume chromatography column. Carbon dioxide is used herein as an example supercritical fluid solvent, however other supercritical fluids and/or combinations of solvents and co-solvents can be used. The supercritical fluid chromatography system 100 shown comprises two chromatography columns 102a and 102b, however the apparatus can also be configured to have only one chromatography column, two chromatography columns as shown, or more than two chromatography columns. Having more than one chromatography column allows for continuous operation and flexibility of the operation. In an example, while one column is running a second or other column can operated in a reverse phase to regenerate the column. The modular design of the presently described SFC system thus allows the equipment and arrangement to be modified to adjust to a variety of production requirements and conditions.

Various types of solid chromatography media (matrix) can be used for the stationary phase matrix of the chromatography column(s) including but not limited to carbon, silica, C8, C18, alkylsilane polymers, microporous materials, porous materials, zeolitic materials, polystyrene-divinyl-benzene synthetic resin, other gel filtration resins, alumina, other types of ion-exchange resin, and mixtures or layered combinations thereof. Other tailored chromatography media may also be used, independently or with other chromatography media, such as molecularly imprinted polymers. The chromatography medium or matrix can also vary widely with regard to particle size, pore size, chemical modification, and other properties to attain the desired separation. When there is the more than one column in the system the column can also comprise the same or different combination of chromatography media or medium packing to achieve the desired separation. The chromatography column can also be of variable length and width depending on the system and setup design; in the case where there is more than one column in the system the two or more columns can have the same or different dimensions, and the same or different stationary phase matrix design. The chromatography column can also be of variable length and width depending on the system and setup design; in the case where there is more than one column in the system the two or more columns can have the same or different dimensions, and the same or different stationary phase matrix design. One or more filters can also added to the system upstream the one or more chromatography columns to treat the raw oil to remove any particulate before the raw oil is injected onto the chromatography column(s). The filter can also capture undesired components from raw plant oils, for example but not limited to pesticides, wax, and chlorophylls, by using materials like, for example, activated magnesium silicate (MagSil). Using a pre-filter can, in some cases, increase the purity of the final isolates and increase the life of the chromatography column stationary phase. In an SFE extraction from plants, the stationary phase matrix is usually a solid matrix, but can also be liquid. The chromatography column size, length, volume, and diameter can vary based on desired output and application, however is sized for preparative chromatography. In an example, chromatography columns used with the present system generally have a volume anywhere from 1 litre to 1000 litres, and can be connected in series or in parallel in the apparatus. In one configuration where every chromatography column vessel is packed with a consistent medium or matrix, the theoretical ‘column volume’ of the apparatus can be greater than 10,000 litres, with each chromatography column having the same or different volume, and the same or different overall dimensions of length and diameter and the same or different chromatography medium. The total volume of the column can also be changed by connecting multiple columns in series. In one example, the ability to fraction between columns has the added benefit of being able to collect later eluting fractions with less total accumulated solvent flow. Alternatively the breaks between columns can also allow for in-line secondary separation of first pass fractions that have been processed by the first chromatography column in the flow path using multiple variations of column material. This technique of connecting multiple chromatography columns in series is referred to as multidimensional chromatography.

An example of the use of multidimensional chromatography for efficient fraction separation of CBD and cannabigerol (CBG) is described as follows. In a single column preparative application where CBD and CBG elute in unison or at approximately the same time under a single ‘peak’ after elution with a first column as detectable by the chemical sensor 104, the eluent flow for the combined CBD-CBG fraction from the first column can be fed into a second column which is packed with a different media that causes a separation of CBD and CBG. Separation of the CBD-CBG fraction after elution through the second column thus enables the collection of isolated CBD and isolated CBG fractions during the secondary chromatographic process. The whole process with two chromatography columns in series can be operated with same the main solvent flow pump, or alternatively with a secondary make-up solvent flow pump, and with the same or different solvent-co-solvent mixture for each column. An advantage of having two or more parallel columns is that the apparatus can be operated continuously, with one column being used for extraction as the other column is being regenerated or cleaned for the next extraction. Supercritical fluid, solvent, or a combination thereof can also optionally be directed through a reverse flow in the column either while the process is still operating or upon shutdown for column regeneration and/or cleaning. In this way the apparatus can carry out separations and extractions in a continuous process. The use of a make-up solvent flow pump can allow for the continuation of multiple chromatography process in less time.

One or more chemical sensor 104 detects the different chemical fractions as they leave the chromatography column(s). The chemical sensor 104 can be connected by a diverter line coming off the main line to run to the sensor. The chemical sensor 104 can also optionally be in-line, and comprise a flow cell or flow lines capable of withstanding the high pressures of the supercritical fluid system. A diverter valve for fluid analytics in the SFC system is used to divert an amount of the process fluid to a chemical sensor. The chemical sensor 104 is used to detect the presence of components coming off of the chromatography column(s) so that the control system can open or close the valves on the collection columns and control the collection of components of interest. The diverter can connect the chemical sensor in-line, where all of the flowing effluent is analyzed, off-line where only a portion of the effluent is taken for analysis, or on-line where a portion of the effluent is analyzed and then returned to the system. The chemical sensor readings are used by the control system to manage the process by opening and closing of the valves on the collection columns and adjusting the co-solvent flow to provide the desired separation. In one method, the raw oil can be analyzed by an analytical chromatography method in advance of the preparative chromatography such that the system can be provided with the expected chromatogram and identification of components to better predict and control the system parameters and collection timing during the preparative chromatography process. The programmed separation instructions provided by the control unit can then adjust the system parameters including but not limited to solvent flow, co-solvent amounts and program, temperatures, and valve timing, to optimize product collection. A variety of types of sensors can be used, including but not limited to a mass spectrometer, and a photodiode array using ultraviolet wavelengths, for detection. Other sensing technologies can be used including ultraviolet (UV) absorption, visible absorption, near infrared (NIR) absorption, and Raman Spectroscopy. Alternative methods of sensing such as in-process microwave sensing can also be used. In the case of a mass spectrometer chemical sensor, various detector types can be used are capable of detecting organic compounds eluted from the chromatography column. The control system can also monitor and record the system conditions optionally with one or more pressure, temperature, and flow rate sensor, optionally outputting the collected data to digital display to a Human Machine Interface (HMI) with LCD screen or to a computing device connected wired or wirelessly to the control system.

Homogenized sample optionally prepared in the sample homogenizer 118 is directed onto a chromatography column 102a, 102b. Crude sample extract or mixture can also be obtained from a chemical reaction or plant extraction process. The sample homogenizer 118 is used for mixing crude oil sample and homogenizing the sample oil for loading onto the chromatography column. The sample loaded onto the chromatography column is preferably a solution of raw oil, optionally in solvent, and preferably free of gross or large particulate which is separated using alternative methods prior to the chromatography process. For purification of cannabis extracts, the input solution can be a broad spectrum cannabis extract oil which is first passed through a filter for particulate and wax removal. Alternatively the input solution can be a broad spectrum cannabis extract containing THC, CBD, CBG, other cannabinoids, terpenes, or oils which has been dewaxed or ‘winterized’. The input sample solution could also be a CBD distillate or other high cannabinoid concentration solution or oil which is desired to be remediated of all other impurities. Homogenization of the input sample can be done with pumps, mixing vessels, and/or with an induced cavitation mixing device as part of the injection assembly. In one example, homogenization can be done by induced cavitation mixing with an induced cavitation mixing apparatus in a sample homogenizer. Induced cavitation in a pressure controlled environment has been found to be effective at mixing and dissolving oils or solid masses in heterogeneous mixtures and can be used to homogenize samples prior to loading onto the chromatography column. Induced cavitation mixers are described in PCT patent application PCT/CA2020/050001 to Seabrook, which is incorporated herein by reference.

The chromatography column is loaded by pouring or pumping the input sample (oil) into a high pressure injection assembly, optionally comprised of a barrel, piston, and actuating device. The injection assembly can be heated and/or some amount of co-solvent, for example ethanol, can be injected into the mixer to control the viscosity of the sample being injected onto the column. An injection assembly pushes the sample onto the packed column through an inlet nozzle and inlet filter plate. The input samples are fluid mixtures under the system operating conditions. In one instance the input sample, for example hemp derived CBD distillate, can be homogenised with the column mobile phase (liquid or supercritical CO₂) and then injected onto the column. In a vertical column arrangement, which is typical but not required for SFC, the injection of the sample onto the chromatography column can be from the top of the column for a top-down column flow configuration or from the bottom of the column for a bottom-up chromatography process. At the end of injection, the injection assembly can be cleaned with flow through mobile phase solvent.

One or more co-solvent tanks 114a, 114b are reservoirs for storing one or more co-solvents or mixtures of co-solvents for mixing with the supercritical fluid solvent that can optionally be added to the supercritical fluid during chromatography and/or extraction. An example and non-limiting list of solvents and co-solvents can be used in supercritical extraction processes, examples of which are shown in Table 1.

TABLE 1

| Solvent | Critical Temperature (° C.) | Critical Pressure (MPa) |
|---|---|---|
| Water | 374.0 | 22.1 |
| Methanol | −34.4 | 8.0 |
| Hexane | 234.5 | 3.0 |
| Ethanol | 243.1 | 6.4 |
| Ethane | 32.4 | 4.8 |
| Isopropanol | 235.6 | 5.37 |
| Nitrous oxide | 36.7 | 7.1 |
| Propane | 96.6 | 4.2 |

Co-solvents can be added in ratios from 0-100% to the supercritical solvent. In one example, solvent ranges as % or ratio to supercritical fluid. In one example CO₂ flow can be on the order of 10 kg/min from 100 ml/min to 10 L/min and the co-solvent or co-solvents used can be dosed in ratios from 0% to 100%. Solubility in a supercritical fluid increases dramatically with increasing fluid density, and different solutes can have different solubility at the same fluid and solvent conditions. In one example, cannabis oil can be extracted best under conditions where temperature ranges from 31.2 to 32.0 degree centigrade and pressure 73.8 to 74 bar. Optimizing solvent composition and mixing in one or more co-solvents to the main working fluid can expedite extraction times and improve system efficiency and extractant yield and purity.

A variety of column conditions can be used and changed to accommodate the type of mixture to be separated. Various conditions can be adjusted, such as solvent and co-solvent ratios, pressures, flow rates, co-solvent types, and each variable can be changed in a chromatography recipe to optimize separation and collection. Working fluid is the general term of fluid being used as the solvent, which includes the supercritical fluid and any co-solvent added to the supercritical fluid. In the present system the preferred working fluid largely comprises supercritical CO₂, optionally mixed with a co-solvent. One or more co-solvent fluid pumps and/or co-solvent valves can be additionally in line to the one or more co-solvent reservoirs to provide and/or pump co-solvent into the system at the desired amount.

Flow measurement is important for ensuring that the proper ratio of co-solvent, also referred to the release agent, is being injected at the proper ratio. The system can comprise multiple flow, pressure, and temperature sensors to ensure the system is operating as desired. In one instance the system could have a pump inlet flow measurement device and a return vapour flow measurement device for determining the proportional amount of co-solvent to inject. Additional and/or optional flow devices, condensers, pumps, and other optional similar devices can be used to restrict, retain, and/or control fluid flow and pressure in the system. Other optional sensors and detection devices can also be used to monitor system conditions including but not limited to flow detection devices, pressure detection devices, temperature detection devices.

The maximum chromatography column load, or the volume of oil capable of processing in the system, is typically defined by a ratio of the column volume. In one instance, for a 45 L chromatography column, a suitable column load could be from 1% to 10% (450 ml to 4.5 L) and optimally around 4% (approximately 2 L). Multiple columns can be run in series, and can also be run in parallel, or a combination of both. With multiple columns in parallel or in series the amount of oil processed can be optimized based on continuous flow of the mobile phase while one column is being re-generated and/or loaded, and one column is performing a chromatography separation. In one instance where the chromatography column is the assembly of multiple packed vessels, the total cumulative solvent flow can be varied in the column. With a chromatography column comprised of two independent vessels of the same volume connected in series with a solvent injection port at the inlet of each column, the bottom and top sections (volumes) of each column can have different co-solvent concentrations. For example, a process with a mobile phase flow of 10 kg/min and a first chromatography column 102a co-solvent injection of 1 kg/min will have a combined flow of 11 kg/min entering the second chromatography column 102b, where an additional co-solvent pump can be injected at 1 kg/min for a total combined flow of 12 kg/min. This could be desirable where the second chromatography column 102b is packed with a media requiring higher co-solvent concentrations to continue elution of desired components and stretch another fraction by increasing the time required for those compounds to travel through the second column volume. Another advantage of having more than one chromatography column in the system is that the process flow can be reversed in the column for cleaning such that that while one chromatography column is being cleaned the other can be in operation. Switching between two or more chromatography columns thus allows for continuous operation of the system as well as additional theoretical column volume which can result in a larger batch processing. The reverse flow could, for example, be any ratio of supercritical fluid and/or co-solvent up to 100%. In one example, pure ethanol can be used as a back wash, optionally at high pressure.

When compounds leave the chromatography column the concentration of the substances are detected and classified by chemical sensor 104. The chemical sensor 104 can also provide additional detail on the component composition, and/or comparison to a chromatogram run on the same sample prior to the preparative chromatography can provide the elution chromatogram pattern such that the same can be matched with less detailed data obtained from chemical sensor 104. Data detected from chemical sensor 104 is sent to the control unit such that the control unit can direct system fluid flow into one of the collection columns 128. FIG. 1 shows six collection columns 128, with each collection column 128 comprising a control valve 130, heat exchanger 132, separator 134 to remove split extractant flow and convert supercritical fluid from the system to gas for separation, a receiver vessel 136 to collect desired compounds, and a collection valve 138. In one example protocol, flow is diverted to a collection column 128 when the sensor detects a ‘low-level’ indicating that the original desired compound has been depleted from the column and a new compound will begin to flow. A control system receiving output from the chemical sensor 104 controls which collection column valve to open depending on the sensor output. In between the elution of desired compounds, the flow can either be collected by a collection column, or directed to a waste stream or waste tank through a bypass flush between the switching of collection columns in the separation series. The control system can also control opening of a collection valve on a waste stream or waste collection column. Similar to the collection columns, the waste stream can comprise a control valve, heat exchanger, separator to recycle supercritical fluid from the system, collection valve, and a receiver vessel, or alternatively a shunt to a waste diverter to remove the waste from the system. The waste stream thus also enables redirection of supercritical fluid back to the system supply while removing waste oils and compounds from the system. A control system controls the opening and closing of valves on each collection column in response to signal detected by the sensor. In the application of collecting a single fraction, the solvent and compound solution can be removed from the receiver vessel and sent for further refinement. In an alternative configuration the system comprises a decompression superheater assembly (DSA) wherein a heat exchanger is positioned upstream the plurality of collection columns 128 (instead of having a single heat exchanger 132 on each column as shown in FIG. 1). Having a single heat exchanger can enable the system to have fewer components, resulting in smaller process piping volume.

Once a collected sample has been processed by the collection column, the product can also be further directed to product homogenizer 120 to mix and homogenize one or more sample product to create a mixture of products. Homogenization of two or more sample products from the system can be useful in the formulation of sample downstream such that a single homogenized product composition can be identified, for example by SKU, instead of requiring individual identification of pure components. In an example, should the desired output of the separation system be a solution of compounds A, B, and C from the complex oil but excluding other components, the output of the separation columns from samples A, B, and C can be directed into the product homogenizer 120. This can be especially useful, for example, when considering the application of pesticide remediation from a plant oil. In particular, a pesticide eluted with the present system can be collected independently and shunted to a waste stream and all other component oils of the plant can be homogenized without the pesticide contaminant. With the present system there is the potential to have a near lossless remediation of the sample oil where all constituents from the plant, minus the undesired components, are recombined in process. This is also particularly important for an application where the desired output of the product is a true representation of the natural plant products. In one example, such as in a cannabis application, it may be desirable to collect all of the plant extracts but perhaps without tetrahydrocannabinol (THC), which is the principal psychoactive constituent of cannabis. This would allow consumers to have a near full spectrum cannabis extract but without THC. In another instance, where the desired output product has a specific ratio of compounds, the system allows for the conversion of ratios. For example, if the desired composition of a finished oil is a ratio of 1A:1 B but the input solution was 3A:1 B, the system could accommodate the removal of 2 parts A so that the discharged solution meets the specification required.

Once CO₂ leaves the collection column(s) 128 it passes through a secondary supercritical fluid separator 108 and filter 122 to remove impurities for recirculation back into the system. The recirculation conduit between the collection columns 128 and liquid reservoir 112 can further comprise one or more returning solvent sensors for sampling the returning CO₂ to ensure that it is substantially free of contamination and to confirm that the returning solvent quality analysis complies with good manufacturing practice (GMP) requirements. The secondary supercritical fluid separator 108 is a gas filter combined with a small particle filter used to remove particulate and impurities that have carried over from collection columns 128. In one example, secondary supercritical fluid separator 108 can have a large bore filter and filter 122 can have a smaller bore filter to remove smaller particulate. Optionally, filter 122 can also be designed to coalesce vapours of co-solvents. Supercritical fluid condenser 110 brings the supercritical fluid CO₂ back to a liquid phase by condensation. One or more additional pump may be used, for example, for addition if a small line is taken off to a detector to provide for a makeup flow to keep the flow rate the same. One or more additional filters can also be used in line to remove any impurities from the CO₂ stream to ensure that the recycled CO₂ is suitable for use in the chromatography process. Filter elements can include, for example, activated carbon for absorption of volatile compounds and molecular sieves for absorption of water. Filter 122 filters out any oil particles and debris that has remained in the CO₂ solvent and supercritical fluid condenser 110. Various other filter elements can also be used including but not limited to coalescence filters and membrane filters such as, for example, cloth, wire, sintered material, or a combination thereof. The filter elements can be replaceable or interchangeable. An optional additional high purity filter can also be integrated into the extraction system. In particular, a coalescing high purity gas filter can be used to scrub any leftover compounds and water vapor from the gas stream.

The supercritical fluid is then returned to its liquid form where it is directed to liquid reservoir 112 for storage or holding. From the separation series, CO₂ is evaporated and recycled, while the receiver vessels hold the desired (fractioned) compound and solvents. To ensure the return CO₂ is of suitable quality a solvent quality analyser can also be added in stream which can validate that the solvent has been properly remediated. Solvent flow with intermittent reverse flow can further be used to dislodge any particles trapped in the filter membrane of filter 122.

To maintain CO₂ in a supercritical fluid state, the SFC system should operate with a pressure above 7.39 MPa (1,071 psi), and temperature above 31.1° C. (88.0 ° F.). To maintain the supercritical fluid flow inside the apparatus, the flow rate could be any value above 0 kg/minute and up to 100 kg/minute or even higher. The desired flow rate of the CO₂ in system depends on the design and production rate. Subcritical conditions for CO₂ is below 7.39 MPa (1,071 psi) and below 31.2 degree centigrade. Preferable extraction conditions for supercritical carbon dioxide are above the critical temperature of 31° C. and critical pressure of 74 bar (1073 psi). The supercritical fluid column chromatography system 100 can be designed to accommodate pressures up to 10,000 psi and from 10-95° C. depending on the selection and density desired. Pressure is controlled by the pump which has an integrated pressure compensating valve, and flow can be controlled by the pump with an integrated proportional flow control valve.

Temperature of the mobile phase is controlled by the phase management system. The phase management system is controlled electronically by the machine control system along with electric and/or gas heating devices. Heat exchangers can be placed at other locations in the apparatus to add or remove heat from the system as needed. A closed loop supercritical fluid recirculation process which is used in this supercritical fluid chromatography (SFC) process requires use of a cooling process to condense CO₂ gas or other supercritical fluid solvent back to a liquid phase for storage and pumping. Refrigeration to condense the supercritical fluid gas can sometimes be more efficient than compression of a gas with applied pressure alone. A liquid process fluid is typically used for this application, delivered via a circulation pump to heat exchangers for this cooling process as well as for chilling the accumulator. This chilling or heat removal process fluid typically comes from an industrial/commercial chilling machine which uses a conventional evaporating heat exchanger chilled by a refrigeration circuit with heat being rejected to the air by a condensing heat exchanger and fan assembly. Occasionally these industrial chilling units will also use a heat recovery process or liquid exchange on the condensing exchanger to use energy/heat for a secondary application. In one embodiment, the present supercritical fluid chromatography system eliminates the need for a process heat transfer fluid by integrating the refrigeration evaporation process and having the refrigeration circuit act directly with the working supercritical fluid process via a high pressure heat exchanger. A refrigerant (such as, for example r404 or r744, etc.) can be supplied by an air or liquid cooled condenser and evaporated in a high pressure heat exchanger integral with the supercritical fluid extraction system to remove heat from the supercritical fluid process causing a condensing phase change. Alternatively, a working fluid cooling system such as water, glycol, or water-glycol mixture can be used. Because the heat removal acts directly on the end working fluid, lower temperatures are attainable via the principle of temperature differential required for transfer in a heat exchanger. The use of an onboard refrigeration circuit also allows for the recovery of heat from the condensing heat exchanger of the refrigeration fluid. The heat recovery via liquid heat transfer can then be used to heat the cyclones and separators in the collection columns as required. The overall balanced heat load system can drastically reduce the power required to operate a SFC system since instead of waste energy being exhausted to the environment via air or liquid, secondary recovery of energy provides for energy reuse and recirculation. The efficient design of an integrated on-board refrigeration circuit can also eliminate the need for both external process heating and process cooling. It is understood that all components of the present system are robust and capable of withstanding the pressures and temperatures required.

The CO₂ or other supercritical fluid can be stored in the system as a liquid in one or more liquid reservoir 112. It is also preferable for the co-solvent to be brought up to temperature and mixed with the supercritical fluid prior to addition to the column or mixing with the homogenized sample. An optional heat recovery system integrated with the apparatus can comprise one or more heat exchangers in the collection columns exchanging heat with the supercritical fluid condenser. Such a heat recovery system can contribute to conservation of energy to run the system and provide heat and energy recovery during system operation. In one example, optional heat exchanger 116 can be on the fluid path between liquid reservoir 112 and chromatography column 102. The 116 heat exchanger can be used to heat or raise the temperature of the CO₂ or other supercritical fluid so it is in a supercritical state before entering the column. The present system can also be small scale, on the order of 250 mL of crude oil per run, or can be a large scale production system continuously processing 100,000 kg or more of crude oil per month.

Other components in the present system can include but are not limited to a condensing heat exchanger, an air cooled process chiller to cool accumulator and/or condenser, an industrial air compressor and a hot water circulating system for the heat exchanger. The SFC system can also have an electronic control system or control unit having circuity and software for controlling one or more of: inputting batch parameters and initiate extraction tracking; monitoring and recording system parameters at defined intervals; printing batch records with associated pressure and temperatures; controlling column parameters based on user input to adjust pressure, temperature, flow, or other process parameters; initiating cleaning cycles; detecting system failures; initiating emergency shutdown procedures; and connecting to one or more networks for monitoring and reporting. In addition, the SFC system can further comprise one or more electric heaters, electric motor controls, emergency stop circuitry, or automatic closure of an accumulator tank, and automatic switching of process valves.

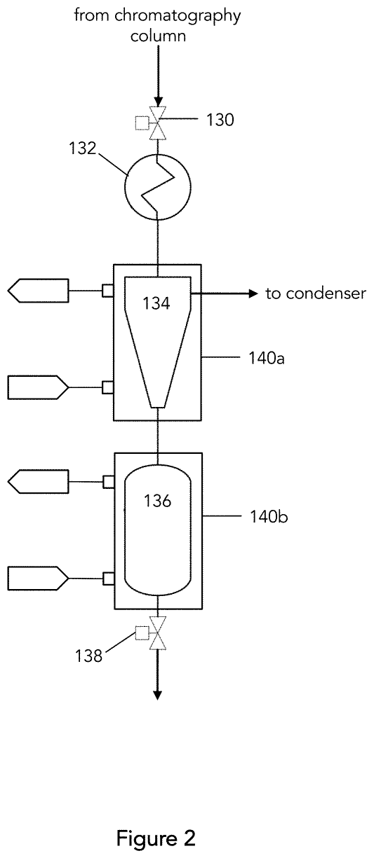

FIG. 2 is a closeup of a collection column in a closed cycle preparative SFC system comprising a collection valve 130, heat exchanger 132, separator 134, receiver vessel 136, and collection valve 138. Separator 134 separates supercritical process fluid from co-solvents and product oil, and is optionally a cyclone separator. The cyclone separator can operate in the gas phase or can be maintained supercritical state and use density to have components drop or precipitate from solution. Heating jackets 140a and 140b maintain the desired temperature in the separator 134 and receiver vessel 136, respectively, with a circulating working fluid. In other system configurations, more than one cyclone separator can be used in each collection column to separated and collect volatile compounds. Each collection column allows for flow to be diverted from the chromatography column based on detection by the chemical detector such that each desirable product of the separation can be collected independently. The control system controls the collection valve to direct entry of the effluent stream from the chromatography column to a particular collection column for removal of supercritical fluid solvent and product or waste retrieval or collection.

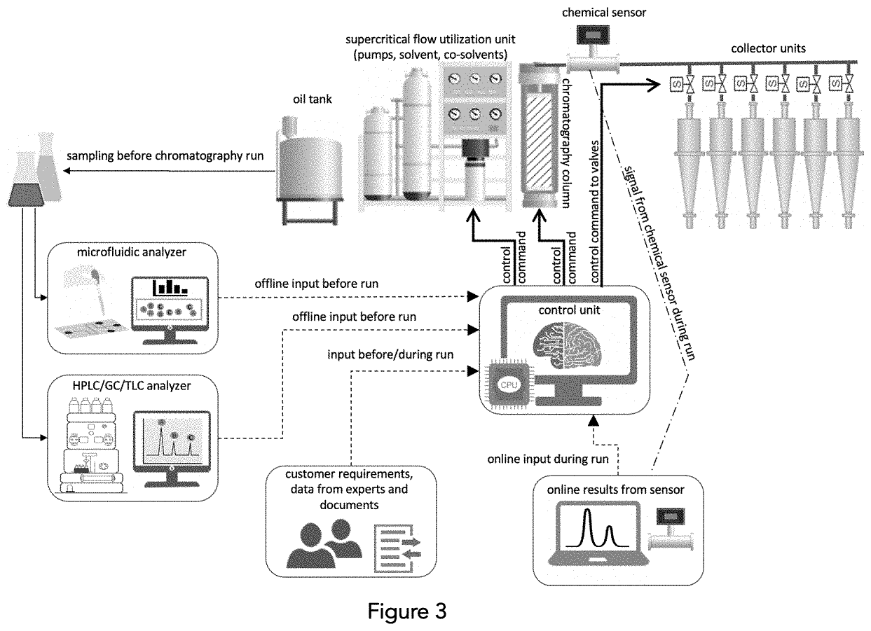

FIG. 3 is a process diagram of a method for closed cycle preparative SFC. In one embodiment, the system utilizes the input from one or more high sensitivity analytical device to predict and interpret the chromatogram produced at the preparative sensor for the preparative system. Analytical evaluation of the input oil sample can be done ahead of time, such that sampling before the preparative chromatography run can predict the expected elution of components for the scale-up chromatography. For example, a bench scale gas chromatograph-mass spectrometer (GC-MS), liquid chromatography-mass spectrometer (LC-MS), thin layer chromatography (TLC), microfluidic analyzer, or micro-fluidic channel gas sensing apparatus can be used to create a chromatogram profile of the expected elution in the industrial scale SFC device based on the characterization of the sample oil. The predicted chromatogram can be complete with component ratios, characterization according to the chemical sensor, and identification of each component. In this way, the chemical sensor in the SFC system can be a low cost, rapid, and robust sensor suitable for the environment required for SFC while still having the process control based on predicted elution results obtained from a higher resolution, more expensive system. In addition, pre-analysis of the process sample material can be used to optimize the chromatography process to achieve the desired separation results. In one example, if the input solution is a full spectrum cannabis oil, a sample profile can be used to program the SFC system for optimal fraction planning, and a protocol comprising amounts of solvent, co-solvent, flow rate, and other factors can be set accordingly. The input solution sample analysis and calculated chromatography instructions, also referred to as a chromatography recipe, can also be based on a desired process such as THC remediation or pesticide remediation from a bulk cannabis oil sample.

Given a pre-process input sample analytical profile the control unit in the system can optimally select and/or adjust a chromatography recipe based on solvent flow, co-solvent amounts, timing, and other control factors. The control unit can provide control commands to the system to control the supercritical flow utilization unit including pumps, solvents, and co-solvents, as well as the chromatography column process settings. During the preparative chromatography run the control unit can also send control command signals to valves on the collector units (also referred to as collection columns) to open and close the appropriate control valve to direct collection of the elution fractions. Online results from the chemical sensor on the preparative SFC system can also be provided to the control unit during the run to provide more accurate control of the control valves on the collector units. Customer requirements and data from previous system operation as well as other data can also be input into the control system before or during the chromatography run to adjust the process parameters and/or the timing of collected fractions. The requirements and application programming based on the input solution sample reduces the need for large numbers and volume of eluent sample collection in process and enables the system to provide separated or mixed fractions as desired. For example, the re-combination of eluent flow allows for the conversion of a full spectrum cannabis oil containing trace amounts of THC or THCa to be collected in a THC/THCa remediated fraction in a single collection vessel resulting in minimal product loss.

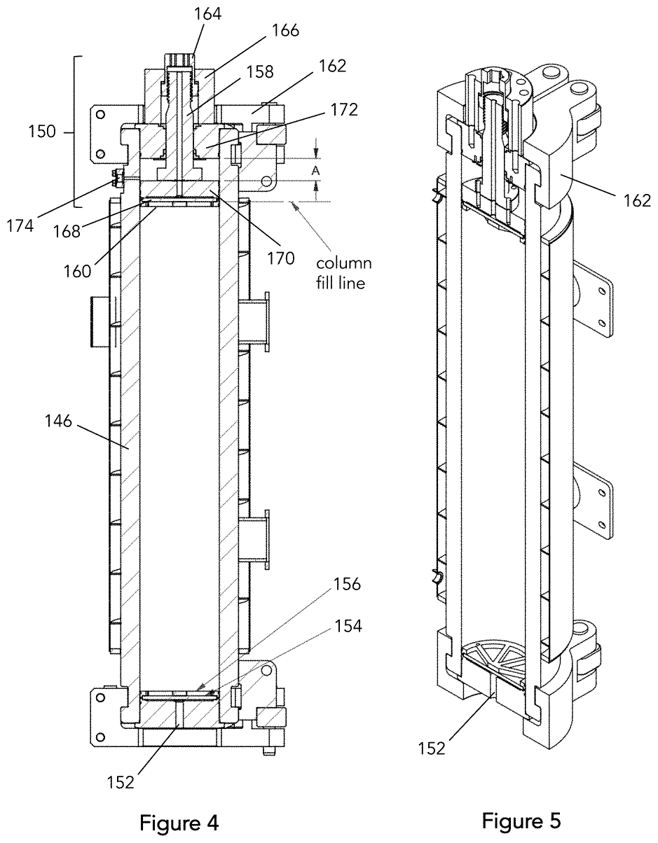

FIG. 4 is a cross-sectional view of a chromatography column for SFC with an integrated column packing device and FIG. 5 is a cross-sectional isometric view of the same chromatography column for SFC with integrated column packing device. Filter plate 154 and filter retainer 156 retain the stationary phase in place in the column body 146 and inlet nozzle 152 provides an inlet of the sample oil and running solvent to the column. In benchtop scale LC and HPLC devices, pre-packed columns are generally purchased from suppliers and come pre-filled with chromatography matrix or medium. However with industrial sized preparative chromatography columns, the columns must be packed in place as the size and weight of a packed column would be prohibitive to ship. In addition, movement of a chromatography column after packing can result in the introduction of matrix packing inconsistencies, bubbles, and differential density, which can result in inconsistent medium and disrupted travel of the sample through the column during the chromatographic separation. Inconsistent column packing matrix can lead to compound peak spreading during chromatography separation, contamination of product, and/or reduced product recovery. In addition, using supercritical fluid as the eluent requires a closed column system to establish appropriate matrix saturation and packing to condition the column prior to chromatography.

The column packing device 150 provides a closed chamber capable of withstanding the temperatures and pressures of SFC with a filter retainer 160 for compressing the matrix and retaining it in place during the elution process. The column packing device 150 sits at the top of the column in both a bottom-up and top-down column configuration and is configured to compact the chromatography matrix inside the column body 146 and also provide stability to the matrix during column operation.

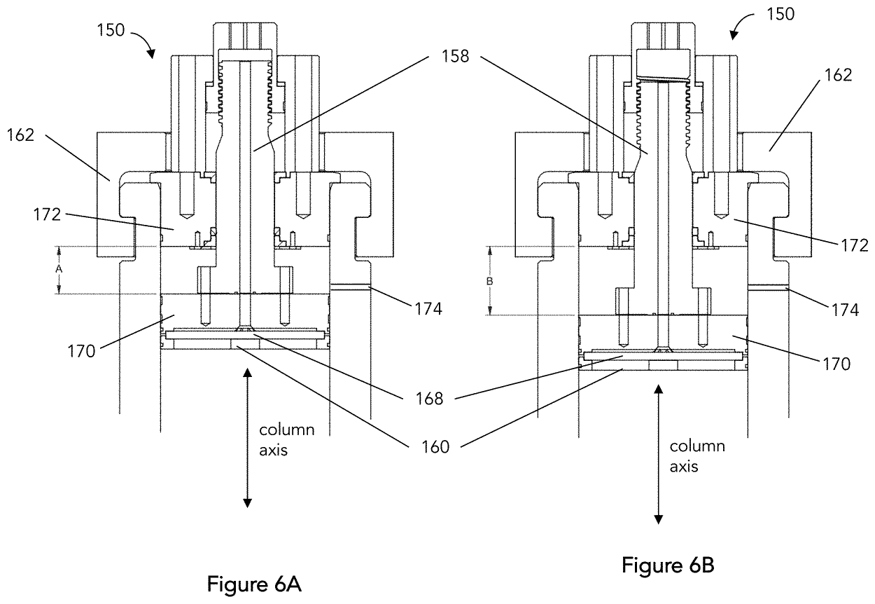

To prepare a preparative SFC column for use in the present system, the column body 146 is first filled with the desired matrix or medium. Once the column is loaded with appropriate resin or stationary phase, the column packing device 150 is inserted onto the column. The column packing device 150 is retained on the column by column cap retainer 162. In the non-compacted state (as shown in FIG. 6A) the piston assembly, which is comprised of filter retainer 160, filter plate 168, and piston 170 which is connected to piston rod 158, is free floating on top of the uncompacted stationary phase. To compact the stationary phase during column conditioning, working fluid is injected through device fluid port 174 into the space between piston 170 and column cap 172 to activate or move the piston and the packing tool downward. As fluid fills the cavity, the piston travels along the column axis toward filter plate 154 and filter retainer 156 at the opposite end of the column. The cavity or void is filled with supercritical fluid or other fluid to expand the volume between cap and piston, thus reducing the column volume. The chromatography column which is filled with a fixed mass of stationary phase is thus compacted which results in a higher density of the stationary phase.

The working fluid of the packing device can be supercritical or liquid CO₂ controlled by a pressure regulating valve or a non-compressible food safe fluid, such as water. As fluid is pumped into the between the top of piston 170 and the bottom of column cap 172, the piston is forced downward. The desired compaction density of the column will be dependent on the desired working pressure of the process, thus the compaction density can be set in advance of the chromatography process to be consistent with the working pressure or above the working pressure. Once the desired compaction density has been achieved, the piston rod 158 is secured in place with locking nut 164, which transfers force to the piston rod retainer 166 to secure the piston 170 in place. The piston rod retainer 166 is integrally connected to the column cap 172. Optionally the piston rod 158 can be threaded to the locking nut 164 or directly to the column cap 172, or any other configuration capable of securing piston rod 158 in place.

When fluid is injected through the device fluid port 174 between the top of piston 170 and the bottom of column cap 172 one or more seals between piston 170 and the column inner surface have a near zero differential pressure by equalization of the pressure on both sided of the piston 170. This minimal differential pressure by pressure equalization through device fluid port 174 and inlet nozzle 152 results in minimal or no extrusion forces on the seals which improves the reliability of the system and integrity of the seals. Minimizing pressure differentials in high pressure supercritical fluid systems also reduces the risk of movement of fine particles and process fluid and reduces leakage. In this particular case, maintaining pressure equalization across the piston assembly also stabilizes the stationary phase and column compaction. The presently described geometry is be applicable to any length and diameter of column. The pressure of the system is restrained by the column cap 150, and the packing side can have pressure compensation to prevent a scenario of high column resistance pressure.

To prepare the preparative SFC column for operation, stationary phase matrix is loaded into the column, optionally as a slurry, until it settles at the column fill line. The column packing piston assembly, comprised of piston rod 158, piston 170, filter plate 168, and compaction filter retainer 160 are fitted into the end of the column and the end cap assembly is locked into place by the column cap retainer 162. Once the column is sealed, fluid pressure is applied to the chromatography column by way of injection of fluid through device fluid port 174 between the cap and the column packing piston 170 and column cap 172. The resulting expansion of the space between piston 170 and column cap 172 moves the packing piston assembly components along the column axis which reduces the effective column volume on the opposite side of the piston assembly. Controlling the fluid pressure to compact the column matrix material allows the system to be compacted at a desired pressure. The pressure of the chromatography column matrix can be packed to various pressures which can be further controlled by the control unit. Notably, the density of the matrix inside the column has an effect on the elution of components in the sample, accordingly changing the packing density of the stationary phase can assist in tuning the system to achieve the desired elution. After the matrix is compacted to its desired pressure, the piston assembly, via the piston rod 158, is secured in place to immobilize the stationary phase and prevent the piston 170 from moving upward when the process fluid is applied to the bottom or top of the column. To disassemble the device, pressure is bled from the column, the column is vented, and the cap retainer assembly is opened. The column can then be cleaned in-situ by releasing the pressure between column packing piston and cap, allowing the mobile phase to move and be washed of debris using a combination of supercritical fluid and optional co-solvents.

The system can allow for quick reconditioning of the stationary phase in the event of contamination, cleaning, or for re-packing as needed. For cleaning purposes without opening the column, the column packing pressure can be relieved by raising the piston 170 and filter retainer 160 to the desired height by releasing locking nut 164 and allowing pressure to be reduced from allowing backflow through device fluid port 174. This allows the piston assembly to move toward column cap 172 and results in expanded space below filter retainer 160 giving the stationary phase in the column room to expand such that it can be aerated with CO₂ or other suitable process fluids or gasses. With a loose column, stationary matrix can be washed with solvents to recondition the column and prepared for repacking.

After each column chromatography run is over, the one or more chromatography column in the system can be regenerated and cleaned. Cleaning solvent can be, for example, high pressure supercritical or subcritical CO₂, a co-solvent like ethanol, other co-solvent, or other cleaning substance like acetone, or a combination thereof. During cleaning the slurry can be aerated from below to stimulate resin or stationary phase movement and washing can be done by reverse injection of an appropriate release solvent or solvent mixture in counter flow of the regular chromatography process. The regeneration can be by running the flow in the same direction as chromatography process, or by backwashing the column after each run or before the chromatography column is reloaded. Although the chromatography column shown has been labeled and configured in the bottom up configuration, the system flow for each chromatography column can be bottom up or top down.

The column discharge can also be directed toward a classification chemical sensor which will automatically decide when a new fraction is present, and cause the control system to allow process flow in a new separator/collection assembly. The chemical sensor can also be used to detect the presence or absence of any contaminants during cleaning or running the column.

FIG. 6A is an enlarged cross-sectional view of the packing piston in an elevated position and FIG. 6B is an enlarged cross-sectional view of the packing piston in a compressed position. Column packing device 150 comprises a piston rod 158, and filter retainer 160 which sits on the top of the stationary phase in the column at a distance A as shown in FIG. 6A. Once the column is sealed and column cap retainer 162 is secured to the top of the column, fluid pressure is applied to the chromatography column fluid. The stationary phase is compacted when working fluid is injected through device fluid port 174 into the space or void between the top of piston 170 and the bottom of column cap 172 pressurizing the space. This activates the piston assembly comprising the filter retainer 160, filter plate 168, piston 170 and piston rod 158 to move downward, compacting the stationary phase inside the chromatography column. The void between the top of piston 170 and the bottom of column cap 172 is shown as A in FIG. 6A. The void is expanded when the void is pressurized by the injection of working fluid causing an increase fluid pressure, where the pressurized space or void expands shown as B in FIG. 6B. Pressurization of the void causes column piston rod 158 and filter retainer 160 to move downward, energized by the fluid pressure. This results in compaction of the stationary phase column matrix to a desired pressure. The filter retainer 160 can then be secured in place to support the stationary phase during chromatography and SFC operation.

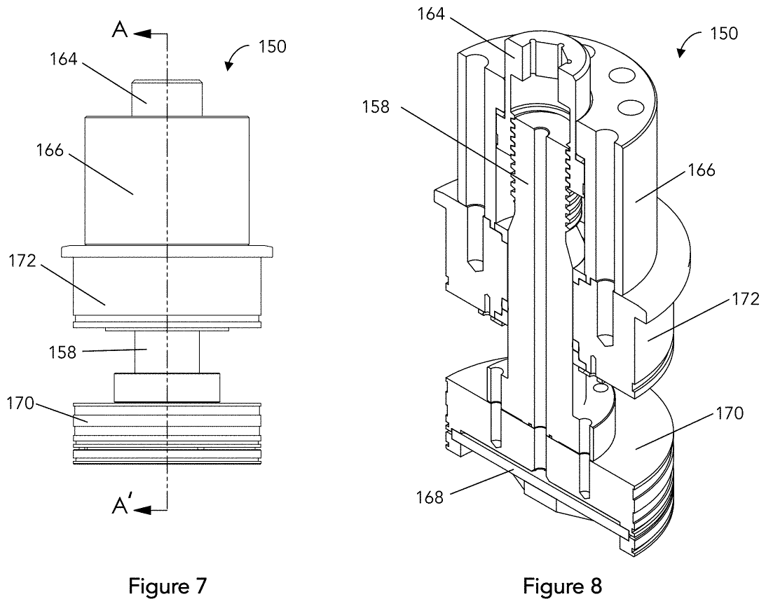

FIG. 7 is a side view of a chromatography column packing device away from the chromatography column. Column packing device 150 comprises piston rod 158 and piston 170 which are supported by column cap 172 and piston rod retainer 166 while allowing piston rod 158 to move along axis A-A′ relative to the chromatography column. Locking nut 164 secures piston rod 158 in position once the column has been packed and pressure equalized in the space between the top of piston 170 and the bottom of column cap 172.

FIG. 8 is an isometric cross-sectional view of a column packing device 150 through axis A-A′ shown in FIG. 7. Piston rod 158 is shown with a threaded top which serves as a locking mechanism to secure piston rod 158 in place when engaged with complementary threading on locking nut 164. Column cap 172 and piston rod retainer 166 have apertures to provide a cylindrical guide for piston rod 158 to move along the column axis during column packing. Piston rod 158 through piston 170 applies pressure to the stationary phase material in the chromatography column through compaction filter plate 168. On the circumferential side of piston 170 are high pressure seals which maintain a fluid tight connection between piston 170 and the chromatography column body. These seals can degrade or become damaged over time, especially when under pressure, and minimizing differential pressure between the bottom and top of the piston 170 by pressurizing the space between the top of piston 170 and the bottom of column cap 172 keeps fluid trapped below and above piston 170 and prolongs the life of these seals.

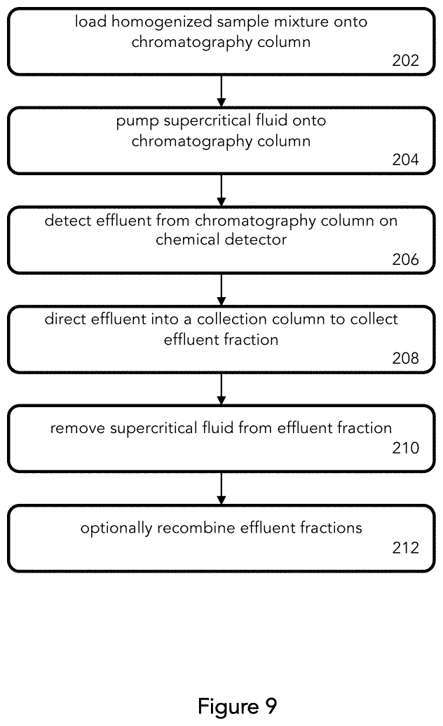

FIG. 9 is a flowchart for a method of separation and fractionation in a supercritical chromatography system. First crude oil is loaded into the homogenizer, and homogenized sample mixture is loaded onto a chromatography column 202. Supercritical fluid is then pumped onto chromatography column 204, optionally also comprising one or more co-solvent. Once sample has traveled through the chromatography column, effluent from the chromatography column is detected on chemical detector 206. The control system receives data from the chemical detector and opens a sample collection valve on a collection column, directing effluent into the collection column to collect an effluent fraction 208. On the collection column supercritical fluid is removed from effluent fraction 210 and re-circulated back into the supercritical fluid flow system. Optionally effluent fractions are recombined 212.

For the chromatography process there are three theoretical states for the mobile phase: liquid (LCO₂); supercritical (SCO₂); and vapor or gaseous state (VCO₂). Normally in this system the mobile phase solvent is either in its liquid or supercritical form. Throughout the system operation and the chromatography process the CO₂ solvent changes state to enable controlled flow, storage, and recovery of supercritical fluid in the system. An example process description of the fluid movement and state of the mobile phase in the chromatography system is provided to illustrate how CO₂ flows and changes state in the system. In this example process, LCO₂ is stored in one or more accumulators (300 psi/0° F.). LCO₂ then enters the pump and is pressurised to the desired operating pressure, for example 400 psi-10000 psi, as a saturated liquid of for example 5000 psi, 10° F.-LCO₂. LCO₂ is then allowed to enter the phase management assembly (PMA) where the fluid temperature is adjusted as needed to achieve the desired operating temperature and phase for the mobile portion of the chromatography column, for example 5000 psi, 150° F.-SCO₂. The mobile phase then enters the chromatography column vessel which is maintained at the same temperature as the phase management assembly to ensure there is no phase change or mobile phase density change in the column during the chromatography process. The CO₂ phase and state are the same entering and exiting the column, for example 5000 psi, 150° F.-SCO₂. The mobile phase then enters a decompression superheater assembly (DSA) via the combination of a pressure reducing valve and heat exchanger, which adds energy to the solvent, increasing the solvent enthalpy prior to separation. This step of the process converts the solvent to SCO₂ in the DSA for both LCO₂ and SCO₂ inlet flows, for example 2000 psi, 150° F.-SCO₂. From the DSA, the mobile phase once again goes through a pressure regulating valve (pressure reduced) and the fluid flashes to a gas in the cyclones, where the column eluents and potentially any co-solvents drop into the collector. The pressure at the collection column can be, for example 300 psi, 50° F.-VCO₂, for liquid co-solvent and liquid cannabinoids. The VCO₂ then exits the cyclone and passes through a variety of filters before arriving at the CO₂ condensers. The VCO₂ is cooled in the condensers with direct refrigeration and LCO₂ leaves the condenser, returning to the accumulator, where the process begins again.

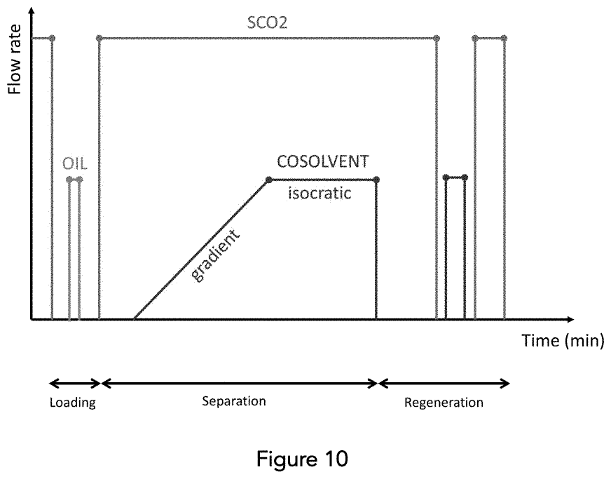

FIG. 10 is a graph of fluid flow for sample oil, mobile phase and co-solvent in a SFC system and shows the timeline of an example recipe and flowrates of the sample oil, solvent and co-solvent. Generally in chromatography, in order to make a relation between the column size, solvent flow rate, and timing of the events during the process, column volume (CV) or more accurately column void is used. Column void is the volume inside the column which fills by mobile phase (solvent) which is column volume, minus the stationary phase volume. In one instance the optimal process run time for complete elution of all compounds through the column is between 4 and 20 column volumes (CV). One column volume is equivalent to the volumetric flow of the mobile phase. For example, with a 40 L column, one ‘column volume’ of time will have passed when 40 L of mobile phase has passed through the column. With a flow rate of 10 L/min, one column volume can be converted to minutes of process time, for example the process time of a 40 L column operating at 10 L/min is 4 minutes. In one instance a complete chromatography process requires 4 column volumes of mobile phase (16 minutes) and in one instance the chromatography process requires 20 column volumes (80 minutes). The number of column volumes required for chromatography separation is impacted by the desired chromatography resolution and yield, column material, input solution to be fractioned, column velocity, temperature, pressure, and co-solvent rate. In one example chromatography procedure, CO₂ is run through the chromatography column neat for a period of time, then a co-solvent such ethanol is added to the CO₂ running solvent for another period of time, then the percentage of the co-solvent is increased. In this example, the sample (OIL) is injected onto to the column using only the carrier solvent (CO₂). The initial run of the system begins with 0% co-solvent and slowly ramps up. The CO₂ and co-solvent are mixed at a desired ratio (in steady state) and then injected into the column.

The complete procedure or recipe of the chromatography defines the process, which is programmed for the system using the control unit and/or is followed by the operator. In one instance for remediation of the cannabis oil and separating the major components of the cannabinoid family, CBD family, CBG family, and THC, the chromatography takes 8 column volumes and the total process from injection of the crude oil to regeneration of the column takes about 10-12 column volume time. The process includes three phases, loading, separation, and regeneration. Loading starts with injection of the crude sample oil to the system. The following is described with a bottom-up chromatography column, however it is understood that the same can be used with a top-down column. After settling of the sample oil mixture at bottom of the column, separation starts by flowing the solvent (for example supercritical CO₂) inside the column. After about one column volume, the co-solvent (e.g. ethanol) will be added to the solvent flow, by a gradient rate from 0% to 5% in 4 column volume. During this gradient time, by adding the co-solvent, CBD and CBG will separate from the crude oil and will be collected in the desired collection vessels. After that, the co-solvent flow is kept constant as an isocratic process which takes 4 column volumes. During this isocratic step, THC and other late eluting cannabinoids will separate from the oil and will be collected in the desired collection vessels. After that, the regeneration phase starts by running the solvent only (supercritical CO₂) inside the column to wash any remaining oil for about 2 column volumes. This washing could be continued by washing the column by running 100% cleaning substance, like the ethanol co-solvent or even a third substance which is used for cleaning purposes. The supercritical CO₂ solvent is then flowed onto the column for about one column volume to ensure that the column is regenerated and returns to its equilibrium state. The column is then ready for the next chromatography run.

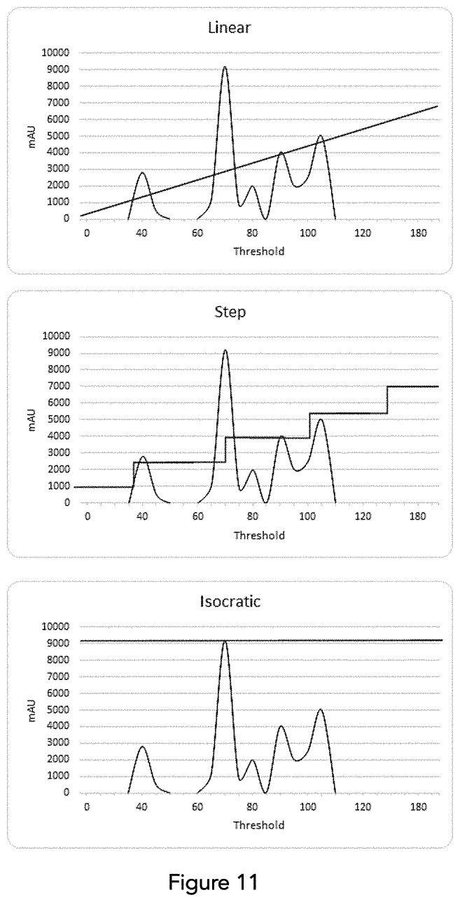

FIG. 11 illustrates different solvent and elution gradient types that can be used in superfluid column chromatography. In particular, shown is the separation of cannabis oil, also known as cannabis concentrates, which are the cannabinoids that come from the female flowers of the cannabis plant. Cannabinoids are not water soluble so to extract them they have to be dissolved in a solvent. Carbon dioxide can be used as an effective solvent for solubilizing and extracting the oil and other components from cannabis. Selecting high cannabis oil plant material or a high yielding cannabis oil strain will maximize yields for oil extraction. When CO₂ is passed through the plant material containing cannabinoids, cannabinoids are dissolved in CO₂ and cannabis oil or concentrates can be obtained. The concentrates can then be liberated by removing CO₂ which is then preferably recycled. To separate and purify the different components, the cannabis oil can be used as a starting material in the present system. Any extraction method can be used for creating a concentrated solution of cannabinoids ready to be fractioned in a chromatography machine.

In chromatography three interrelated variables which impact the production rate and quality of the process are resolution, speed, and capacity. The general principal of chromatography is that the various constituents of the mixture travel at different speeds according to the selectivity of the mobile phase due to its polarity. SCO₂ has a low polarity while a co-solvent like ethanol has higher polarity. Varying the composition of the mobile phase will change the sequence and time of the extraction components in the mobile phase and helps to tune the resolution, speed and capacity of the run. If the composition of the mobile phase remains constant during the time of the chromatography process, the separation is deemed an isocratic elution. In a linear chromatography protocol the fraction of co-solvent in the running solvent changes at a constant rate overtime. In contrast, in a step protocol the amount of co-solvent in the main running solvent or mobile phase is stepped up one or more times during the elution. Changing the protocol enables better separation of components and thereby cleaner extracted fractions of pure product. Often the only way to elute all of the compounds in the sample in a reasonable time while still maintaining peak resolution is to change the ratio of polar to non-polar compounds in the mobile phase during the run. This is also referred to gradient chromatography. Shifting between isocratic and gradient can improve separation and the slope of the change can be done by changing the ratio and identity of the co-solvent(s) in the mobile phase.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

I claim:

1. A supercritical fluid column chromatography system comprising:
a chromatography column comprising a stationary phase;
a chemical sensor downstream the chromatography column for detecting chemical species eluted from the chromatography column;
a heat exchanger downstream the chemical sensor;
a plurality of collection columns downstream the chemical sensor, each collection column comprising, in series:
a collection control valve receiving fluid to the collection column; and
a separator to separate supercritical process fluid from product;
a supercritical fluid collector fluidly connected with the separator on each of the plurality of collection columns;
a supercritical fluid condenser fluidly connected to the supercritical fluid collector;
a fluid reservoir fluidly connected to the supercritical fluid condenser and the chromatography column; and
a control system for controlling the collection valve on each of the plurality of collection columns based on detection of chemical species at the chemical sensor.

2. The system of claim 1, further comprising a co-solvent tank upstream the chromatography column.

3. The system of claim 1, wherein the separator in the collection column is a cyclone separator.

4. The system of claim 1, further comprising a diverter fluidly connected to the chemical sensor.

5. The system of claim 1, wherein the chemical sensor is an off-line sensor, an in-line sensor, or an on-line sensor.

6. The system of claim 1, comprising a plurality of chromatography columns.

7. The system of claim 6, wherein the plurality of chromatography columns are arranged in sequence, in series, or a combination thereof.

8. The system of claim 1, wherein the sensor is selected from a mass spectrometer, photodiode array using ultraviolet wavelengths, ultraviolet (UV) sensor, visible light sensor, near infrared (NIR) sensor, Raman spectrometer, microwave sensor, or a combination thereof.

9. A method of separating components in a mixture in a supercritical fluid flow system, the method comprising:
loading a sample mixture onto a chromatography column;
pumping pressurized supercritical fluid onto the chromatography column;
detecting effluent from the chromatography column with a chemical sensor;
receiving data, at a control system, from the chemical sensor indicating the presence of a component fraction in the effluent;
controlling, with the control system, a sample collection valve on a collection column to collect the component in the effluent; and
re-circulating the supercritical fluid from the collection column back into the supercritical fluid flow system.

10. The method of claim 9, further comprising adding a co-solvent to the supercritical fluid.

11. The method of claim 9, wherein the co-solvent is ethanol, methanol, isopropanol, hexane, or a combination thereof.

12. The method of claim 9, wherein component fractions are recombined downstream the collection column.

13. The method of claim 9, comprising directing component fractions to different collection columns.

14. A method of preparing the stationary phase of a supercritical chromatography column comprising:
filling the chromatography column with stationary phase;
applying a column packing device to the stationary phase, the column packing device comprising a column cap sealing the chromatography column and a piston movable along the column axis relative to the column cap;
pumping supercritical fluid onto the stationary phase in the chromatography column;
injecting fluid between the column cap and the piston to activate movement of the piston away from the column cap;
compacting the stationary phase with the piston; and
securing the piston in place to immobilize the stationary phase.

15. The method of claim 14, wherein the chromatography column is a preparative chromatography column.

16. The method of claim 14, wherein the chromatography column is in a supercritical fluid chromatography system.

17. The method of claim 14, wherein the chromatography column has a volume of between 1 litre to 10,000 litres.

18. A column packing device for a supercritical fluid chromatography column comprising:
a column cap secured to the chromatography column;
a piston for applying pressure to stationary phase inside the chromatography column, the piston movable along the column axis relative to the column cap;
a packing piston rod coupled to the piston; and
a fluid port between the piston and the column cap,
wherein injection of fluid through the fluid port between the column cap and the packing piston activates movement of the piston away from the column cap to pressurize the stationary phase.

19. The device of claim 18, further comprising a regulator to regulate the pressure differential between the column packing device and the chromatography column.

20. The device of claim 18, further comprising a locking mechanism to immobilize the piston relative to the column cap.
